(19) United States
(12) Patent Application Publication
(10) Pub. No.: US 2017/0089551 A1
(43) Pub. Date: Mar. 30, 2017

(54) ILLUMINATION CEILING LAMP AND SNAP RING THEREOF

(71) Applicant: DONGGUAN YINGHUI LIGHTING CO., LTD., Dongguan (CN)

(72) Inventor: Shuisheng XU, Dongguan (CN)

(21) Appl. No.: 15/273,998

(22) Filed: Sep. 23, 2016

(30) Foreign Application Priority Data
Sep. 24, 2015 (CN) 201520746727.4

(51) Int. Cl. F21V 17/16; F21V 17/12; F21S 8/04

(52) U.S. Cl. CPC F21V 17/164; F21S 8/04; F21V 17/12; F21V 1/02

(57) ABSTRACT

An illumination ceiling lamp comprises a lamp shade, a lamp holder installed in the lamp shade and a snap ring which is fixed on the lamp holder. The top of the lamp shade is provided with a spacing portion, be provided with a mounting hole in the spacing portion; the lamp holder penetrates through the mounting hole; the lamp holder includes a lamp stand and a light. The outside surface of the lamp stand is provided with an external screw thread; the snap ring includes a main portion and a bearing portion connected to the circumferential surface of the main portion. The main portion is tubular; the inside surface of the main portion is provided with an internal screw thread adaptive to the external screw thread on the lamp stand, and the snap ring is connected to the lamp stand through the screw threads and props against the spacing portion.

### FIELD OF THE INVENTION

The present patent relates to an illumination lamp, in particular to an illumination ceiling lamp convenient to mount and a snap ring thereof.

### BACKGROUND OF THE INVENTION

At present, an ordinary ceiling lamp generally consists of a power cord, a lamp shade, a lamp holder cap, a cord clip pole, a lamp stand, a light and a snap ring. Such lamp stand has the defects of inconvenience in assembly, poor universality and the like. When the lamp shades which are different in shapes of openings and have different widths and different radians of inner walls, or other accessories are assembled, it is necessary to customize the snap rings according to different types, to result in poor applicability and incapability of satisfying customer demands.

Further, the existing snap ring structure is designed improperly. When the lamp shade is heavier, the positioning snap ring for the lamp holder and the lamp shade reaches a fatigue limit to possibly loose after used for a long time, thus resulting in potential safety hazards and causing low market acceptance level.

### SUMMARY OF THE INVENTION

Based on this, it is necessary to provide an illumination ceiling lamp independent of the shape of a lamp shade, and a snap ring thereof against the defects of the prior art.

A snap ring is installed on a lamp holder of an illumination ceiling lamp to limit a lamp shade, being provided with an external screw thread on the lamp holder, wherein the snap ring is T-shaped and comprises a main portion and a bearing portion which is provided at one end of the outer surface of the main portion, the main portion is tubular, the inside surface of the main portion is provided with an internal screw thread, and the internal screw thread is in thread fit with the external screw thread on the lamp holder.

Further, the bearing portion is annular, and the outer diameter of the bearing portion is gradually increased from the end part to the inner side.

Further, the circumferential edge of the bearing portion is provided with a plurality of grooves that extend inwards, the grooves in the bearing portions are spaced to each other, and a snap tooth is formed between every two adjacent grooves.

Further, a flange is convexly provided outwards on the circumferential surface, which is far away from one end of the bearing portion, of the snap ring.

Further, the illumination ceiling lamp comprises a lamp shade, a lamp holder installed in the lamp shade and a snap ring which is fixed on the lamp holder, wherein the top of the lamp shade is provided with a spacing portion, be provided with a mounting hole in the spacing portion; the lamp holder penetrates through the mounting hole; the lamp holder includes a lamp stand and a light installed at one end of the lamp stand, wherein the outside surface of the lamp stand is provided with an external screw thread; the snap ring includes a main portion and a bearing portion connected to the circumferential surface of the main portion, wherein the main portion is tubular; and the inside surface of the main portion is concavely provided with an internal screw thread which is in thread fit with the external screw thread on the lamp stand, the bearing portion of the snap ring props against the spacing portion of the lamp shade, and one end, which is far away from the light, of the lamp stand penetrates through the mounting hole and extends out of the lamp shade.

Further, the bearing portion is annular, and the outer diameter of the bearing portion is gradually increased from the end part to the inner side.

Further, the circumferential edge of the bearing portion is provided with a plurality of grooves that extend inwards, the plurality of grooves in the bearing portions are spaced to each other, and a snap tooth is formed between every two adjacent grooves.

Further, the lamp shade is square; the spacing portion consists of a plurality of support bars and a mounting ring, wherein two ends of each support bar are connected to the inside wall of the lamp shade and the outside edge of the mounting ring respectively; the support bars connected to the mounting ring are distributed radially; the support bars are spaced to each other; the lamp holder is installed in the mounting ring; and the snap ring is installed on the lamp holder below the mounting ring and props against the mounting ring.

Further, the lamp shade is semispherical, and the top of the lamp shade is provided with a horizontal section to form the spacing portion.

Further, the lamp shade is horn-shaped.

Compared with the prior art, the snap ring of the present patent may be applicable to lamp shades which are different in shapes of openings and have different widths and different radians of inner walls, or other accessories with good fitting capability, and is convenient to mount and simple in structure. Furthermore, the design of the bearing portion on the snap ring has increased the stress area of the snap ring, such that the bearing capacity of the snap ring is greatly promoted and the snap ring is safer and more reliable.

### BRIEF DESCRIPTION OF THE DRAWINGS

FIG. 1 is a structural schematic drawing of the first embodiment of the illumination ceiling lamp of the present patent;

FIG. 2 is a structural schematic drawing of the snap ring of the illumination ceiling lamp of FIG. 1;

FIG. 3 is a structural schematic drawing of the second embodiment of the illumination ceiling lamp of the present patent;

FIG. 4 is a structural schematic drawing of the snap ring of the illumination ceiling lamp of FIG. 3;

FIG. 5 is a structural schematic drawing of the third embodiment of the illumination ceiling lamp of the present patent; and

FIG. 6 is a structural schematic drawing of the fourth embodiment of the illumination ceiling lamp of the present patent.

### DETAILED DESCRIPTIONS OF THE PREFERRED EMBODIMENTS

In order to make the purpose, the technical solution and the advantages of the present patent more clearly, the present patent is further illustrated in details below in conjunction with the drawings and the embodiments.

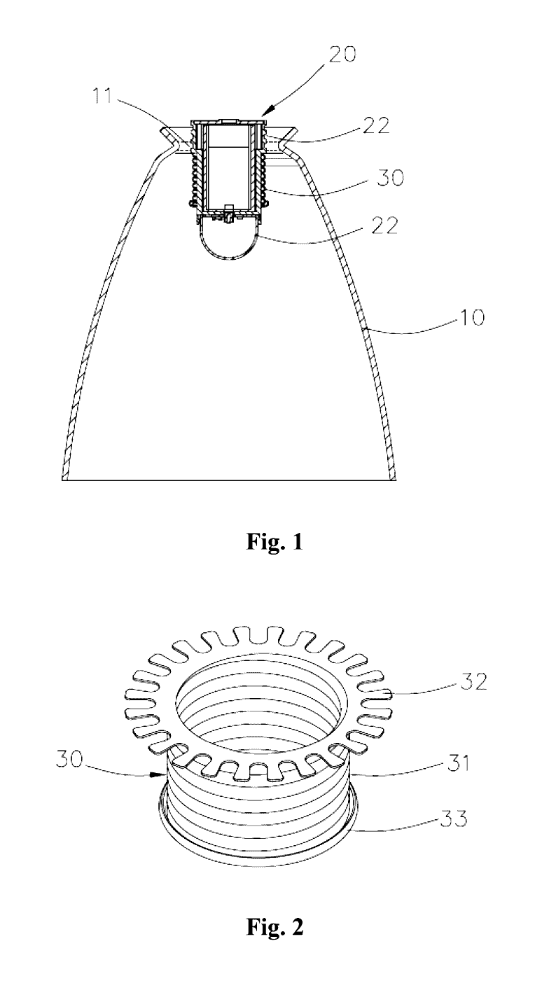

FIG. 1 and FIG. 2 illustrate the first embodiment of the illumination ceiling lamp of the present patent. The illumination ceiling lamp comprises a lamp shade 10, a lamp holder 20 installed in the lamp shade and a snap ring 30 which is installed on the lamp holder 20. The lamp shade 10 is horn-shaped, wherein the bottom of the lamp shade 40 is provided with an open end. An open end in the top of the lamp shade 40 is bottleneck-shaped, and a spacing portion 11 in which a mounting hole 11 is formed is provided in the open end in the top of the lamp shade 40. The lamp holder 20 is installed in the mounting hole of the spacing portion 11 and comprises a lamp stand 21 and a light 22 which is installed at the bottom of the lamp stand 21, wherein the lamp stand 21 is cylindrical, the outside surface of the lamp stand 21 is provided with an external screw thread, one end, which is close to the light 22, of the lamp stand 21 extends into the lamp shade 10, and one end, which is far away from the light 22, of the lamp stand 21 extends out of the lamp shade 10.

The snap ring 30 is T-shaped and comprises a main portion 31 and a bearing portion 32 which is connected to the circumference surface of the main portion, wherein the main portion 31 is tubular, the bearing portion 32 is provided at the top of the main portion 31, the bearing portion 32 surrounds the outer surface of the main portion 31, the circumferential edge of the bearing portion 32 is provided with a plurality of grooves which extend inwards, the grooves in the bearing portion 32 are spaced to each other, and a snap tooth 34 is formed between every two adjacent grooves. A flange 33 is convexly provided outwards on the edge of one end, which is far away from the bearing portion 32, of the snap ring 30. The inside surface of the main portion 31 of the snap ring 30 is provided with an internal screw thread which is adaptive to the external screw thread on the lamp stand 21. The internal screw thread of the main portion 31 is in thread fit with the external screw thread on the lamp stand 21. The bearing portion 32 of the snap ring 30 props against the spacing portion 11 of the lamp shade 10. The snap ring 30 is spirally fixed to the lamp stand 21 at two sides of the spacing portion of the lamp shade 40, such that the lamp shade 10 and the lamp holder 20 are mounted more firmly. Moreover, when the lamp shade 10 is installed on the lamp holder 20, because the lamp shade 10 has a certain weight, the stress area of the snap ring 30 can be increased by additionally arranging the bearing portion 32 on the snap ring 30, such that the capability of the snap ring to bear the weight of the lamp shade 10 is greatly improved, and the snap ring 30 is safer and more reliable.

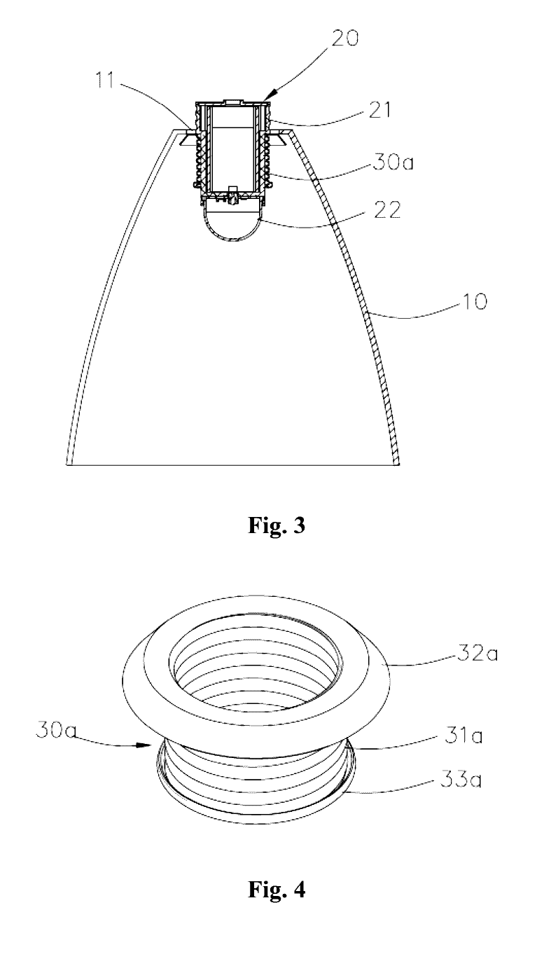

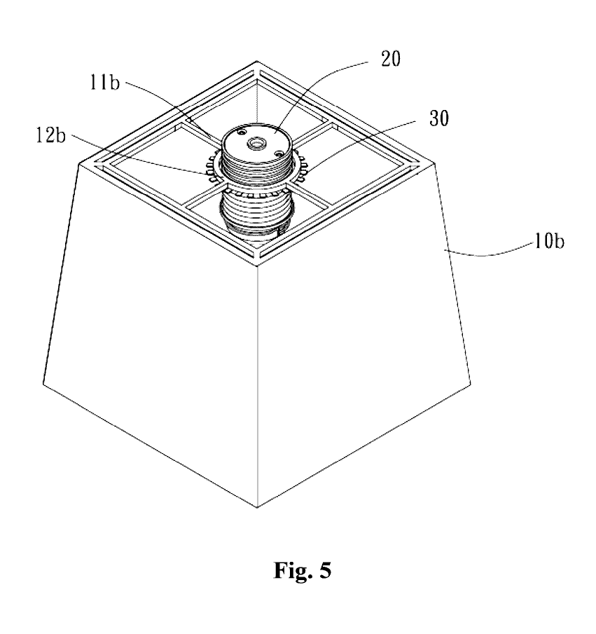

FIG. 3 and FIG. 4 illustrate the second embodiment of the snap ring of the present patent. The illumination ceiling lamp of this embodiment, which is similar to that of the first embodiment, also comprises a lamp shade 10, a lamp holder 20 and a snap ring 30a. The snap ring 30a is T-shaped and comprises a main portion 31a and a bearing portion 32a connected to the circumferential surface of the main portion. The main portion 31a is tubular. The bearing portion 32a is provided at the top of the main portion 31a. The illumination ceiling lamp of this embodiment has the differences in that the bearing portion 32a is annular and the outer diameter of the section of the bearing portion 32a is gradually increased from the tail end to the inner side.

FIG. 5 illustrates the third embodiment of the illumination ceiling lamp of the present patent. The illumination ceiling lamp of this embodiment, which is similar to that of the first embodiment, also comprises a lamp shade 10b, a lamp holder 20 and a snap ring 30 and has the differences in that the open end at the top of the lamp shade 10b is square, and the spacing portion 11b consists of a plurality of support bars 11b and a mounting ring 12b, wherein two ends of each support bar 11b are connected with the side wall of the lamp shade 10b and the outside edge of the mounting ring 12b respectively. The support bars 11b connected to the mounting ring 12b are distributed radially, and the support bars 11b are spaced to each other. The lamp shade 20 is installed in the mounting ring 12b. The snap ring 30 is installed on the lamp stand 21 below the mounting ring 12b and props against the mounting ring 12b to limit the mounting ring 12b.

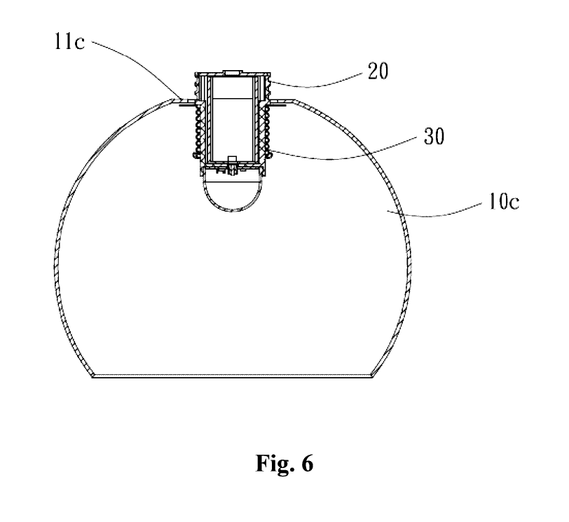

FIG. 6 illustrates the fourth embodiment of the illumination ceiling lamp of the present patent. The illumination ceiling lamp of this embodiment, which is similar to that of the first embodiment, also comprises a lamp shade 10c, a lamp holder 20 and a snap ring 30 and has the differences in that the lamp shade 10c is semispherical, the top of the lamp shade 10c is provided with a horizontal section to form the spacing portion 11c, a through hole is formed in the center of the spacing portion 11c, the lamp holder 20 is installed in the through hole, and the snap ring 30 is spirally installed on the lamp stand 21 below the mounting ring 12c and props against the inside surface of the horizontal section 11c.

From the above, the snap ring of the present patent may be applicable to lamp shades 10 which are different in shapes of openings and have different widths and different radians of inner walls, or other accessories with good fitting capability, and is convenient to mount and simple in structure. Furthermore, the design of the bearing portion 32 on the snap ring 30 has increased the stress area of the snap ring 30, such that such that the capability of the snap ring 30 to bear the weight of the lamp shade 10 is greatly improved, and the snap ring 30 is safer and more reliable.

The embodiments aforementioned just express an implementation of the present patent, and its description is more specific and detailed, but may not be hereby interpreted to limit the patent scope of the present patent. It should be pointed out that, for the common skilled in the art, a plurality of variations and modifications may be made on the premise of not departing from the concept of the present patent and should be considered to fall into the scope of the present patent. Therefore, the patent protection scope of the present patent should be subject to the attached claims.

What is claimed is:

1. A snap ring, which is installed on a lamp holder of an illumination ceiling lamp to limit a lamp shade, being provided with an external screw thread on the lamp holder, wherein the snap ring is T-shaped and comprises a main portion and a bearing portion which is provided at one end of the outer surface of the main portion, the main portion is tubular, the inside surface of the main portion is provided with an internal screw thread, and the internal screw thread is in thread fit with the external screw thread on the lamp holder.

2. The snap ring of claim 1, wherein the bearing portion is annular, and the outer diameter of the bearing portion is gradually increased from the end part to the inner side.

3. The snap ring of claim 1, wherein the circumferential edge of the bearing portion is provided with a plurality of grooves that extend inwards, the plurality of grooves in the bearing portion are spaced to each other, and a snap tooth is formed between every two adjacent grooves.

4. The snap ring of claim 1, wherein a flange is convexly provided outwards on the outer surface, which is far away from the bearing portion, of the snap ring.

5. An illumination ceiling lamp, comprising a lamp shade, a lamp holder provided in the lamp shade and the snap ring which is fixed on the lamp holder, wherein the top of the lamp shade is provided with a spacing portion, be provided with a mounting hole in the spacing portion; the lamp holder penetrates through the mounting hole; the lamp holder includes a lamp stand and a light installed at one end of the lamp stand, wherein the outside surface of the lamp stand is provided with an external screw thread; the snap ring includes a main portion and a bearing portion connected to the circumferential surface of the main portion, wherein the main portion is tubular; and the inside surface of the main portion is concavely provided with an internal screw thread which is in thread fit with the external screw thread on the lamp stand, the bearing portion of the snap ring props against the spacing portion of the lamp shade, and one end, which is far away from the light, of the lamp stand penetrates through the mounting hole and extends out of the lamp shade.

6. The illumination ceiling lamp of claim 5, wherein the bearing portion is annular, and the outer diameter of the bearing portion is gradually increased from the end part to the inner side.

7. The illumination ceiling lamp of claim 5, wherein the circumferential edge of the bearing portion is provided with a plurality of grooves that extend inwards, the plurality of grooves in the bearing portion are spaced to each other, and a snap tooth is formed between every two adjacent grooves.

8. The illumination ceiling clamp of claim 5, wherein the lamp shade is square; the spacing portion consists of a plurality of support bars and a mounting ring, wherein two ends of each support bar are connected to the inside wall of the lamp shade and the outside edge of the mounting ring respectively; the support bars connected to the mounting ring are distributed radially; the support bars are spaced to each other; the lamp holder is installed in the mounting ring; and the snap ring is installed on the lamp holder below the mounting ring and props against the mounting ring.

9. The illumination ceiling lamp according to claim 5, wherein the lamp shade is semispherical, and the top of the lamp shade is provided with a horizontal section to form the spacing portion.

10. The illumination ceiling lamp of claim 5, wherein the lamp shade is horn-shaped.
